(19) United States
(12) Patent Application Publication
(10) Pub. No.: US 2008/0184978 A1
(43) Pub. Date: Aug. 7, 2008

(54) DRIVING FORCE CONTROL APPARATUS FOR VEHICLE

(75) Inventors: Ayumu Sagawa, Toyota-shi (JP); Koji Oshima, Nagoya-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 12/025,274

(22) Filed: Feb. 4, 2008

(30) Foreign Application Priority Data
Feb. 5, 2007 (JP) 2007-025820

(51) Int. Cl. F02D 45/00

(52) U.S. Cl. 123/679; 477/115; 701/51

(57) ABSTRACT

In one embodiment, when control of a throttle opening degree is limited due to the occurrence of an electronic throttle failure, a determination is made of whether or not an intake manifold negative pressure of an engine is inadequate, and when determined that intake manifold negative pressure is inadequate, a gear ratio of an automatic transmission is shifted (for example, downshifted) to a gear ratio that increases an intake pipe negative pressure, thus increasing the intake pipe negative pressure (absolute value).

### CROSS-REFERENCE TO RELATED APPLICATION

This application claims priority under 35 U.S.C. § 119(a) on Japanese Patent Application No. 2007-025820 filed in Japan on Feb. 5, 2007, the entire contents of which are herein incorporated by reference.

### BACKGROUND OF THE INVENTION

1. Field of the Invention

The present invention relates to a driving force control apparatus for a vehicle that is equipped with an internal combustion engine and an automatic transmission, and uses intake pipe negative pressure of the internal combustion engine as brake booster negative pressure.

2. Description of the Related Art

In a vehicle equipped with an internal combustion engine (below, also referred to as an engine), as a gearshift apparatus that appropriately transmits torque and rotational velocity produced by the engine to a drive axle according to the running state of the vehicle, automatic transmission is known that automatically sets an optimum gear ratio between the engine and the drive axle.

As an automatic transmission equipped in a vehicle, there is, for example, a planetary gear transmission that sets the gear ratio (gear) using a clutch, a brake and planetary gear apparatus, and a belt-type gearless transmission that gearlessly adjusts the gear ratio (CVT: continuously variable transmission).

In a vehicle equipped with a planetary gear-type automatic transmission, a gearshift map that has gearshift lines (lines where gears are switched) for obtaining an optimum gear according to vehicle speed and an accelerator opening degree is stored in an ECU (Electronic Control Unit) or the like, a target gear is calculated with reference to the gearshift map based on the vehicle speed and the accelerator opening degree, and based on that target gear, the gear (gear ratio) is automatically set by engaging or releasing, in predetermined states, one or more clutch elements, one or more brake elements, one or more one-way clutch elements, or the like, which are frictionally engaging elements.

A belt-type gearless transmission, for example, is a transmission that realizes successive gearless shifting using a metal belt and a pair of pulleys by changing the effective diameter of the pulleys with oil pressure, and is used with the endless metal belt winding around spanning between an input side pulley and an output side pulley. The input side pulley and the output side pulley are provided with a sieve that can gearlessly adjust a groove width, and by changing the groove width with the sieve, the diameter of winding the endless metal belt around the input side pulley and the output side pulley changes, and thus it is possible to successively gearlessly change a revolutions ratio i.e. the gear ratio between an input shaft and an output shaft.

Also, an electronic throttle system is known in which the engine installed in the vehicle is provided with an actuator (throttle motor) that drives a throttle valve provided in an intake path, so that it is possible to control the throttle opening degree independent of operation of an accelerator pedal by a driver.

In the electronic throttle system, the throttle opening degree is controlled such that an optimum amount of air intake (target air intake amount) according to the operating state of the engine, such as the number of engine revolutions and the degree to which the driver depresses the accelerator pedal (accelerator opening degree), is obtained. Specifically, the actual throttle opening degree of the throttle valve is detected using a throttle opening degree sensor or the like, and feedback control of the actuator of the throttle valve is performed such that the actual throttle opening degree matches the throttle opening degree that can provide the above target air intake amount (target throttle opening degree). Also, in the electronic throttle system, the throttle valve is open even during idle operation, and feedback control of idle revolutions is performed by adjusting the opening of the throttle valve such the actual idle revolutions match the target idle revolutions (ISC: Idle Speed Control).

In this sort of an electronic throttle system, (below, also referred to as simply an ‘electronic throttle’), when a throttle opening degree sensor and a throttle motor, or a control system, have malfunctioned, a control during failure of fixing the throttle valve to predetermined opening degree is performed in order to allow emergency running of the vehicle (for example, see JP H6-2574A).

On the other hand, as a driving force control apparatus for a vehicle, an apparatus is known in which a brake booster is installed in order to obtain strong brake braking force by lightly depressing the brake pedal, and negative pressure of that brake booster is insured with negative pressure of an intake pipe of the engine (below, also referred to as intake manifold negative pressure).

In a driving force control apparatus in which intake manifold negative pressure is used as brake booster negative pressure, the intake manifold negative pressure (absolute value) may sometimes fall when decelerating. When the intake manifold negative pressure falls, the brake booster negative pressure becomes inadequate, and thus depressing force on the brake pedal increases. Therefore, it is important that during normal engine operation, deceleration downshift lines on the automatic transmission side are determined such that the intake manifold negative pressure when decelerating is not more than a predetermined criteria (the magnitude (absolute value) of the intake manifold is not less than a predetermined threshold value).

Incidentally, in a vehicle equipped with an automatic transmission and an electronic throttle, as described above, the throttle valve opening degree is fixed at a particular value (for example, 6°) regardless of the accelerator opening degree, in order to guarantee “forward vehicle movement (emergency running)” and “engine stop prevention” during electronic throttle failure.

On the other hand, because the intake manifold negative pressure of the engine changes depending on the state of the engine, when the throttle opening degree is fixed to a predetermined opening degree during electronic throttle failure, the intake manifold negative pressure may become inadequate depending on the state of the engine. For example, if electronic throttle failure occurs and the throttle opening degree is fixed when the vehicle is running in a high gear, a torque state of the engine may become a driving state (a state in which the drive axle is driven by torque that has been output from the engine), and the intake manifold negative pressure may fall. When, in this manner, the intake manifold negative pressure falls, there is a risk that depressing force on the brake pedal will increase, resulting in an increased operating burden on the driver.

When electronic throttle failure has occurred, the opening degree of the throttle valve is fixed regardless of operation (accelerator opening degree) of the accelerator pedal, so that the relationship between the accelerator opening degree and the actual throttle opening degree is broken, and thus it is not possible to avoid a reduction in the intake manifold negative pressure by setting of gearshift lines on the automatic transmission side or the like.

### SUMMARY OF THE INVENTION

The present invention provides a driving force control apparatus for a vehicle equipped with an internal combustion engine and an automatic transmission connected to the internal combustion engine, the vehicle using intake pipe negative pressure of the internal combustion engine as brake booster negative pressure, the vehicle driving force control apparatus including: a throttle control means for controlling a throttle opening degree of the internal combustion engine; a malfunction detecting means for detecting a malfunctioning state of the throttle control means; a throttle control limiting means for limiting control of the throttle opening degree when a malfunction has been detected by the malfunction detecting means; a gearshift control means for controlling a gear ratio of the automatic transmission; and a negative pressure determining means for determining whether or not the intake pipe negative pressure of the internal combustion engine is inadequate when control of the throttle opening degree is being limited; wherein when the negative pressure determining means has determined that the intake pipe negative pressure is inadequate, the gearshift control means controls the gear ratio of the automatic transmission so as to shift to a gear ratio that increases the intake pipe negative pressure of the internal combustion engine.

According to such a configuration, when control of the throttle opening degree is limited due to a malfunction of an electronic throttle (electronic throttle failure), a determination is made of whether or not intake pipe negative pressure (intake manifold negative pressure) of the internal combustion engine is inadequate, and if the intake pipe negative pressure is inadequate, intake pipe negative pressure (absolute value) is increased by shifting the gear ratio of the automatic transmission to a gear ratio that increases intake pipe negative pressure (a gear ratio that increases driven torque). Therefore, for example, when running at a high speed in a high gear ratio (a high gear), even if electronic throttle failure occurs, it is possible to insure intake pipe negative pressure, i.e. brake booster negative pressure. Moreover, it is possible to insure intake pipe negative pressure during an electronic throttle failure without controlling the throttle opening degree in a failed state, and without adding a hardware structure.

In one example of a specific configuration of the present invention, the automatic transmission equipped in the vehicle is a planetary gear-type automatic transmission of a geared type that has a planetary gear-type gearshift mechanism, in which a plurality of gears are set by engaging or releasing one or more engaging elements in predetermined states; and when the negative pressure determining means has determined that the intake pipe negative pressure is inadequate, the gearshift control means downshifts the gear of the planetary gear-type automatic transmission.

Also, when a vehicle is equipped with such a planetary gear-type automatic transmission, a configuration may be adopted that further includes an output shaft revolutions detecting means for detecting the number of revolutions of an output shaft of the planetary gear-type automatic transmission; and a gear determining means for determining the present gear of the planetary gear-type automatic transmission; in which the negative pressure determining means comprises a table in which an allowable gear that can insure intake pipe negative pressure is set for each of predetermined output shaft revolutions regions, the negative pressure determining means obtains an allowable gear based on the number of output shaft revolutions by referring to the table, compares the allowable gear to the present gear, and when the result of that comparison is that the allowable gear is less than the present gear, determines that intake pipe negative pressure is inadequate, and executes a downshift of the planetary gear-type automatic transmission.

Also, as another specific configuration, it is possible to adopt a configuration in which when the negative pressure determining means has determined that the intake pipe negative pressure is inadequate, when a downshift of the planetary gear-type automatic transmission is executed, an engaging oil pressure of one or more engaging-side engaging elements of the planetary gear-type automatic transmission is set higher than during ordinary control.

According to this configuration, even in a circumstance in which, due to fixing of the throttle opening degree during electronic throttle failure, the number of engine revolutions (number of input shaft revolutions of the automatic transmission) do not rise to a gear-synchronized number of revolutions after downshifting, by increasing the engaging oil pressure of one or more engaging elements when shifting gears, it is possible to reliably raise the number of input shaft revolutions of the planetary gear-type automatic transmission to the gear-synchronized number of revolutions after downshifting.

Also, note that in the present invention, the automatic transmission equipped in the vehicle is not limited to being a planetary gear-type automatic transmission; the automatic transmission may also be a belt-type gearless transmission (CVT).

### BRIEF DESCRIPTION OF THE DRAWINGS

FIG. 1 is an overall configuration diagram that shows an example of a vehicle driving force control apparatus according to the present invention.

FIG. 2 is an engagement table that shows engagement/release of engagement elements of the automatic transmission shown in FIG. 1.

FIG. 3 is a block diagram that shows the configuration of a control system such as an ECU.

FIG. 4 shows a gearshift map used in gearshift control.

FIG. 5 is a flowchart that shows an example of a control during electronic throttle failure.

FIG. 6 is a flowchart that shows an example of a control during electronic throttle failure.

FIGS. 7A and 7B show an allowable gear table used in the control during electronic throttle failure in FIG. 5.

FIG. 8 illustrates a manual downshift control.

### DESCRIPTION OF THE PREFERRED EMBODIMENTS

Hereinafter, embodiments of the present invention will be described in detail with reference to the accompanying drawings.

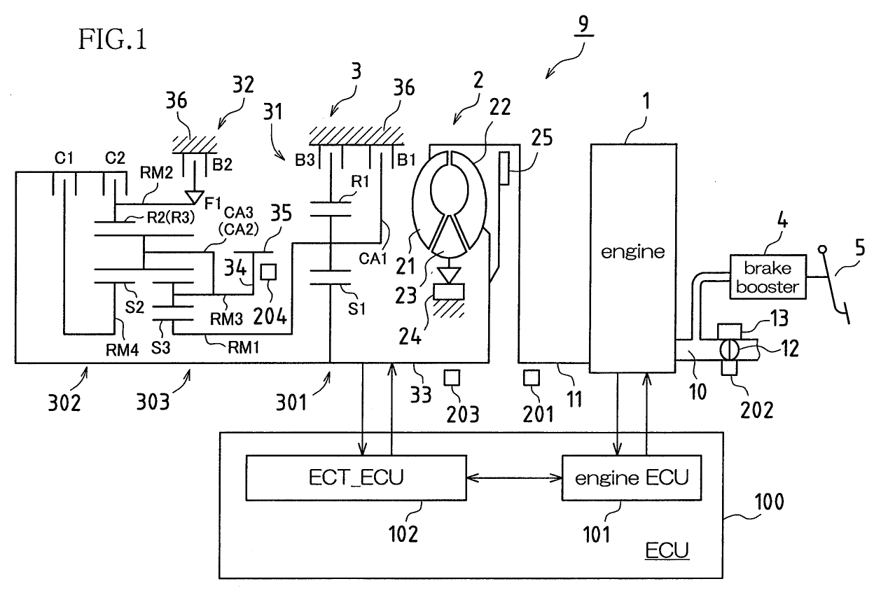

Following is a description of a powertrain of a vehicle that includes the driving force control apparatus of the present invention. The vehicle driving force control apparatus in this example is realized by a program that is executed by an ECU 100 shown in FIG. 1.

As shown in FIG. 1, a vehicle 9 is equipped with an engine (internal combustion engine) 1, a torque converter 2, an automatic transmission 3, and an ECU 100. Following is a description of each portion of the engine 1, the torque converter 2, the automatic transmission 3, and the ECU 100.

-Engine-

The engine 1, for example, is a four-cylinder gasoline engine, and a crankshaft 11 serving as an output shaft is connected to an input shaft of the torque converter 2. The number of revolutions of the crankshaft 11 (number of engine revolutions) is detected by an engine revolutions sensor 201.

An amount of air intake sucked into the engine 1 is adjusted by an electronically controlled (electronic throttle system) throttle valve 12. The throttle valve 12 is capable of electronically controlling a throttle opening degree independent of accelerator pedal operation by a driver, and the throttle opening degree is detected by a throttle opening degree sensor 202.

The throttle opening degree of the throttle valve 12 is driven and controlled by the ECU 100. Specifically, the ECU 100 controls the throttle opening degree of the throttle valve 12 such that an optimum amount of air intake (target air intake amount) according to the operating state of the engine 1, such as the number of engine revolutions detected by the engine revolutions sensor 201 and the degree to which the driver depresses the accelerator pedal (accelerator opening degree), is obtained. More specifically, the actual throttle opening degree of the throttle valve 12 is detected using the throttle opening degree sensor 202, and feedback control of a throttle motor 13 of the throttle valve 12 is performed so that the actual throttle opening degree matches the throttle opening degree that can provide the above target air intake amount (target throttle opening degree).

Also, a brake booster 4 is connected to an intake pipe (intake manifold) 10 of the engine 1. The brake booster 4 operates due to negative pressure within the intake pipe 10 (intake manifold negative pressure), and thus boosts the force (braking force) of a depressing operation of a brake pedal 5.

-Torque Converter-

The torque converter 2 is provided with an input shaft-side pump impeller 21, an output shaft-side turbine impeller 22, a stator 23 that manifests a torque amplification function, and a one-way clutch 24, the torque converter 2 transmitting force between the pump impeller 21 and the turbine impeller 22 via a liquid.

The torque converter 2 is provided with a lockup clutch 25 that puts the input side and the output side in a directly linked state, and by completely engaging the lockup clutch 25, the pump impeller 21 and the turbine impeller 22 rotate integrally. Also, by engaging the lockup clutch 25 in a predetermined slip state, the turbine impeller 22 rotates following the pump impeller 21 with a predetermined slip amount during driving. The torque converter 2 and the automatic transmission 3 are connected by a rotating shaft.

-Automatic Transmission-

The automatic transmission 3 is a transversely mounted automatic transmission applied in an FF (Front engine/Front drive) vehicle, and as shown in FIG. 1, and has, on a coaxial line, a first gearshift portion 31 configured mainly from a single pinion-type first planetary gear apparatus 301, and a second gearshift portion 32 configured mainly from a single pinion-type second planetary gear apparatus 302 and a double pinion-type third planetary gear apparatus 303. Thus the automatic transmission 3 is a planetary gear-type gearshift device that changes the speed of rotation of an input shaft 33, transmits the rotation to an output shaft 34, and output from an output gear 35. The output gear 35 is linked, directly or via a counter shaft, to a differential gear apparatus installed in the vehicle. Note that the automatic transmission 3 is configured approximately symmetric relative to a center line, so the half below the center line is omitted in FIG. 1.

The first planetary gear apparatus 301 used to configure the first gearshift portion 31 is provided with three rotating elements, i.e., a sun gear S1, a carrier CA1, and a ring gear R1, and the sun gear S1 is linked to the input shaft 33. Further, the ring gear R1 is fixed to a housing 36 via a third brake B3, so that the sun gear S1 is rotated in a decelerating manner relative to the input shaft 33 with the carrier CA1 serving as an intermediate output member.

With the second planetary gear apparatus 302 and the third planetary gear apparatus 303 used to configure the second gearshift portion 32, due to portions thereof being linked to each other, four rotating elements RM 1 to RM 4 are configured. Specifically, the first rotating element RM 1 is configured by a sun gear S3 of the third planetary gear apparatus 303, and the second rotating element RM 2 is configured by a ring gear R2 of the second planetary gear apparatus 302 and a ring gear R3 of the third planetary gear apparatus 303 being linked to each other. Further, the third rotating element RM 3 is configured by a carrier CA2 of the second planetary gear apparatus 302 and a carrier CA3 of the third planetary gear apparatus 303 being linked to each other. The fourth rotating element RM 4 is configured by a sun gear S2 of the second planetary gear apparatus 302.

In the second planetary gear apparatus 302 and the third planetary gear apparatus 303, the carriers CA2 and CA3 are configured with a common member, and the ring gears R2 and R3 are configured with a common member. Further, the second planetary gear apparatus 302 and the third planetary gear apparatus 303 are a Ravigneaux-type planetary gear array in which the pinion gear of the second planetary gear apparatus 302 also serves as a second pinion gear of the third planetary gear apparatus 303.

The first rotating element RM 1 (sun gear S3) is integrally linked to the carrier CA1 of the first planetary gear apparatus 301, which is an intermediate output member, and the first rotating element RM 1 is rotated/stopped by being selectively linked to a housing 36 by the first brake B1. The second rotating element RM 2 (ring gears R2 and R3) is selectively linked to the input shaft 33 via the second clutch C2, and the second rotating element RM 2 is rotated/stopped by being selectively linked to the housing 36 via a one-way clutch F1 and the second brake B2.

The third rotating element RM 3 (carriers CA2 and CA3) is integrally linked to the output shaft 34. The fourth rotating element RM 4 (sun gear S2) is selectively linked to the input shaft 33 via the first clutch C1.

Each of the first clutch C1, the second clutch C2, the first brake B1, the second brake B2, and the third brake B3 is a multi-plate-type hydraulic frictionally engaging apparatus in which those members frictionally engages due to a hydraulic cylinder.

In the above automatic transmission 3, the first clutch C1, the second clutch C2, the first brake B1, the second brake B2, the third brake B3, the one-way clutch F1, and the like, which are frictionally engaging elements, are engaged or released in predetermined states, thus setting a gear.

In the automatic transmission 3, a shift lever operated by the driver is provided, and by operating that shift lever, it is possible to switch to, for example, P range (parking range), R range (reverse running range), N (neutral range), D range (forward running range), or the like.

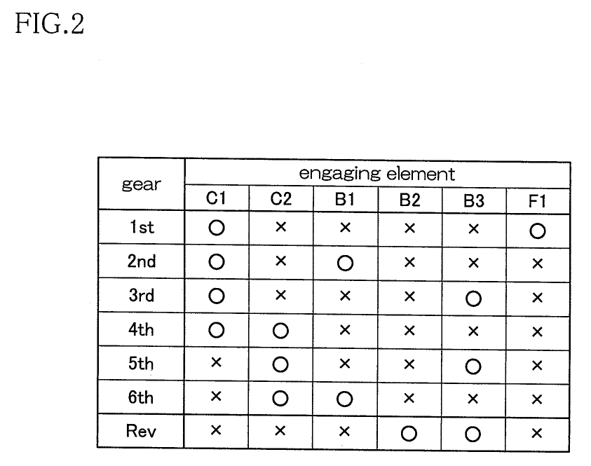

FIG. 2 is an engagement table that illustrates engagement operations of clutches and brakes in order to establish each gear of the automatic transmission 3, in which “∘” indicates engagement and “x” indicates release.

As shown in FIG. 2, in the automatic transmission 3, a first gear (1st) is established by engaging the first clutch C1. Shifting (1st to 2nd) from the first gear (1st) to a second gear (2nd) is achieved by engaging the first brake B1.

Shifting (2nd to 3rd) from the second gear (2nd) to a third gear (3rd) is achieved by releasing the first brake B1 and engaging the third brake B3. Shifting (3rd to 4th) from the third gear (3rd) to a fourth gear (4th) is achieved by releasing the third brake B3 and engaging the second clutch C2.

Shifting (4th to 5th) from the fourth gear (4th) to a fifth gear (5th) is achieved by releasing the first clutch C1 and engaging the third brake B3. Shifting (5th to 6th) from the fifth gear (5th) to a sixth gear (6th) is achieved by releasing the third brake B3 and engaging the first brake B1.

A reverse gear (Rev) is established by engaging both the second brake B2 and the third brake B3.

The gear ratios of the gears of the automatic transmission 3 are determined as appropriate by respective gear ratios (=number of teeth of sun gear/number of teeth of ring gear) ρUD, ρS, and ρD of the first planetary gear apparatus 301, the second planetary gear apparatus 302, and the third planetary gear apparatus 303.

The number of revolutions of the input shaft 33 of the above automatic transmission 3 is detected by an input shaft revolutions sensor 203. The number of revolutions of the output shaft 34 of the automatic transmission 3 is detected by an output shaft revolutions sensor 204. Based on a ratio of revolutions (output revolutions/input revolutions) obtained from output signals of the input shaft revolutions sensor 203 and the output shaft revolutions sensor 204, it is possible to determine the present gear of the automatic transmission 3.

-ECU-

The ECU 100 that controls the above powertrain includes an engine ECU 101 that controls the engine 1, and an ECT_ECU (Electronically Controlled automatic Transmission_ECU) 102 that controls the torque converter 2 and the automatic transmission 3.

The engine ECU 101 and the ECT_ECU 102 are each provided with a CPU, a ROM, a RAM, a backup RAM, and the like.

In the ROM, various control programs, maps referred to when executing those various control programs, and the like are stored. The CPU executes computational processes based on the various control programs and the maps that have been stored in the ROM. The RAM is a memory in which results of computation with the CPU, data that has been input from each sensor, and the like are temporarily stored, and the backup RAM is a nonvolatile memory that stores data in the RAM to be saved or the like when the engine 1 stops.

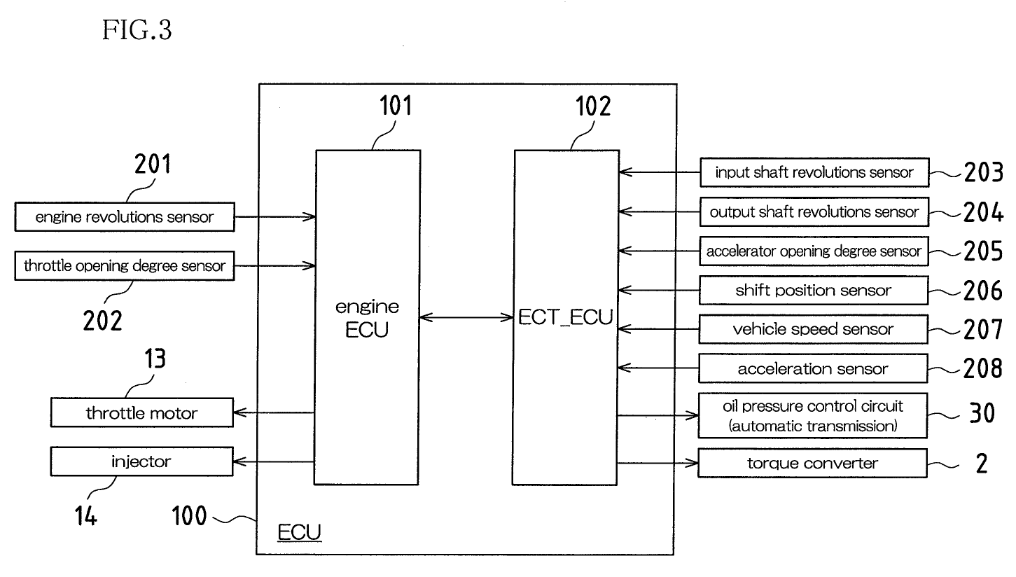

As shown in FIG. 3, various sensors that detect the driving state of the engine 1, such as the engine revolutions sensor 201 and the throttle opening degree sensor 202, are connected to the engine ECU 101, and signals from those respective sensors are input to the engine ECU 101. The engine ECU 101 controls each portion of the engine 1, such as the throttle motor 13 of the throttle valve 12 and an injector (fuel injection valve) 14.

As shown in FIG. 3, the input shaft revolutions sensor 203, the output shaft revolutions sensor 204, an accelerator opening degree sensor 205 that detects the opening degree of the accelerator pedal, a shift position sensor 206 that detects the shift position of the automatic transmission 3, a vehicle speed sensor 207 that detects the speed of the vehicle, an acceleration sensor 208 that detects the degree of acceleration of the vehicle, and the like are connected to the ECT_ECU 102.

The ECT_ECU 102 outputs a lockup clutch control signal to the torque converter 2. Engaging pressure of the lockup clutch 25 is controlled based on this lockup clutch control signal. Further, the ECT_ECU 102 outputs a solenoid control signal (oil pressure instruction signal) to an oil pressure control circuit 30 of the automatic transmission 3. A linear solenoid valve, an on-off solenoid valve, and the like of the oil pressure control circuit 30 are controlled based on this solenoid control signal, and the first clutch C1, the second clutch C2, the first brake B1, the second brake B2, the third brake B3, the one-way clutch F1, and the like of the automatic transmission 3 are engaged or released in predetermined states so as to configure predetermined gears (1st to 6th).

The engine ECU 101 sends respective signals of the accelerator opening degree detected by the accelerator opening degree sensor 205 and the number of engine revolutions detected by the engine revolutions sensor 201, downshift requests described below, and the like to the ECT_ECU 102. The ECT_ECU 102 sends signals of the number of input shaft revolutions detected by the input shaft revolutions sensor 203, the number of output shaft revolutions detected by the output shaft revolutions sensor 204, the accelerator opening degree detected by the accelerator opening degree sensor 205, and the like to the engine ECU 101.

The engine ECU 101 executes an “idle revolutions control” and “throttle control during failure” described below. The ECT_ECU 102 executes a “gearshift control” and “deceleration flex control” described below.

-Idle Revolutions Control-

The idle revolutions control is a control executed when the engine 1 is in idle operation, in which feedback control of the amount of air intake into the engine 1 is performed by adjusting the opening degree of the throttle valve 12 such that the actual number of idle revolutions during idle operation matches the target number of idle revolutions. Specifically, feedback control of the amount of air intake into the engine 1 is performed by, based on the operating state of the engine 1, calculating the target idle revolutions with reference to a map or the like, reading the actual number of idle revolutions (number of engine revolutions) from the output signal of the engine revolutions sensor 201, and controlling the opening degree of the throttle valve 12 such that the actual number of idle revolutions matches the target number of idle revolutions.

-Throttle Control During Failure-

In this example, when there is a breakdown (electronic throttle failure) of the throttle opening degree sensor 202, the throttle motor 13, or a control system, in order to guarantee forward vehicle movement (emergency running) and prevention of an engine stall, control of the throttle opening degree is limited (prohibited), and the opening degree of the throttle valve 12 is fixed to a certain value (for example, 6°) by a mechanical apparatus such as a spring.

Here, as the method for detecting electronic throttle failure, a method is adopted in which, for example, using the fact that a non-linear throttle opening degree obtained from the accelerator opening degree and the actual throttle opening degree have a fixed relationship when the electronic throttle operates properly, the electronic throttle is determined to have failed when the difference between the non-linear throttle opening degree and the actual throttle opening degree is more than a predetermined value. The accelerator opening degree used for this failure determination is calculated from the output signal of the accelerator opening degree sensor 205, and the actual throttle opening degree is calculated from the output signal of the throttle opening degree sensor 202.

-Gearshift Control-

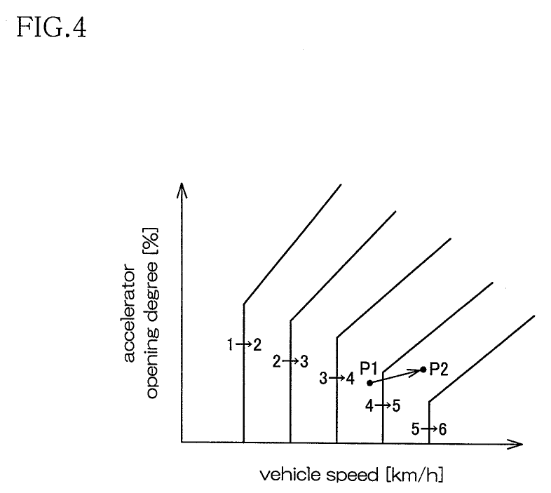

First is a description of a gearshift map used in the gearshift control of this example, with reference to FIG. 4.

In the gearshift map shown in FIG. 4, the vehicle speed and the accelerator opening degree are used as parameters, and a plurality of regions for obtaining an appropriate gear have been set according to the vehicle speed and the accelerator opening degree. This gearshift map is stored in the ROM of the ECT_ECU 102. The regions of the gearshift map are demarcated by a plurality of gearshift lines (gear switching lines). Note that in the gearshift map shown in FIG. 4, only upshift gearshift lines are shown.

Following is a description of the basic operation of the gearshift control.

The ECT_ECU 102 calculates the vehicle speed from the output signal of the vehicle speed sensor 207, calculates the accelerator opening degree from the output signal of the accelerator opening degree sensor 205, and calculates the target gear based on the calculated vehicle speed and accelerator opening degree, with reference to the gearshift map in FIG. 4. Further, the ECT_ECU 102 determines the present gear by obtaining the ratio of revolutions (number of output revolutions/number of input revolutions) obtained from the output signals of the input shaft revolutions sensor 203 and the output revolutions shaft sensor 204, and determines whether or not a gearshift operation is necessary by comparing the present gear to the target gear.

When the result of that determination is that a gearshift is not necessary (when the present gear is the same as the target gear, and thus the gear is appropriately set), the ECT_ECU 102 outputs a solenoid control signal (oil pressure instruction signal) that maintains the present gear to the oil pressure control circuit 30 of the automatic transmission 3.

On the other hand, when the present gear is not the same as the target gear, the gearshift control is performed. For example, from a situation in which the vehicle is running with the gear of the automatic transmission 3 in “4th gear”, when the running state of the vehicle changes, for example, from point P1 to point P2 shown in FIG. 4, a upshift gearshift line is crossed over in the shift map from 4 to 5, so the target gear calculated from the gearshift map is “5th gear”, a solenoid control signal (oil pressure instruction signal) that sets that 5th gear is output to the oil pressure control circuit 30 of the automatic transmission 3, and thus a gearshift from 4th gear to 5th gear (upshift from 4th to 5th) is performed.

-Deceleration Flex Control-

Next is a description of the deceleration flex control.

First, in the torque converter 2, when controlling the lockup clutch 25 that allows direct linkage of the input side and the output side, feedback control (slip control) is performed according to the difference between the number of revolutions of the input-side pump impeller 21 (same as the number of engine revolutions) and the number of revolutions of the output-side turbine impeller 22, so as to obtain a predetermined engaging force of the lockup clutch 25.

On the other hand, in the engine 1, fuel cutting is performed during accelerator-off deceleration. During fuel cutting, the torque state of the engine 1 is a driven state (a state in which the engine 1 is driven by torque that has been input from the vehicle wheels), so a sudden decrease in the number of revolutions of the engine is suppressed by performing the above slip control of the lockup clutch 25 such that an engine stall does not occur. A control in which slip control of the lockup clutch 25 is executed at the time of fuel cutting during accelerator-off deceleration in this manner is referred to as the “deceleration flex control”.

In order to realize this sort of deceleration flex control, the ECT_ECU 102 controls the engaging pressure of the lockup clutch 25 based on the number of input revolutions of the torque converter 2 (number of engine revolutions), the number of revolutions of the turbine impeller 22 (number of turbine revolutions), the throttle opening degree of the engine 1, the vehicle speed, and the like.

Incidentally, because intake manifold negative pressure of the engine 1 changes in response to the state of the engine 1, if the throttle opening degree is fixed at a predetermined opening degree during electronic throttle failure, there may be instances when the intake manifold negative pressure is inadequate depending on the state of the engine 1. For example, when the vehicle is running in a high gear, and electronic throttle failure occurs and the throttle opening degree is fixed, the torque state of the engine 1 may be in a driving state, and thus the intake manifold negative pressure may decrease. When the intake manifold negative pressure decreases in this manner, there is a risk that the depressing force of the brake pedal 5 will increase and thus the operating burden of the driver will also increase.

In consideration of this point, the distinguishing feature of the present example is that, in a vehicle in which the intake manifold negative pressure is used as the brake booster negative pressure, when control of the throttle opening degree is limited due to the occurrence of an electronic throttle failure, a determination is made of whether or not the intake manifold negative pressure of the engine 1 is inadequate, and when determined that the intake manifold negative pressure is inadequate, the intake manifold negative pressure (brake booster negative pressure) is insured by performing a downshift of the automatic transmission 3.

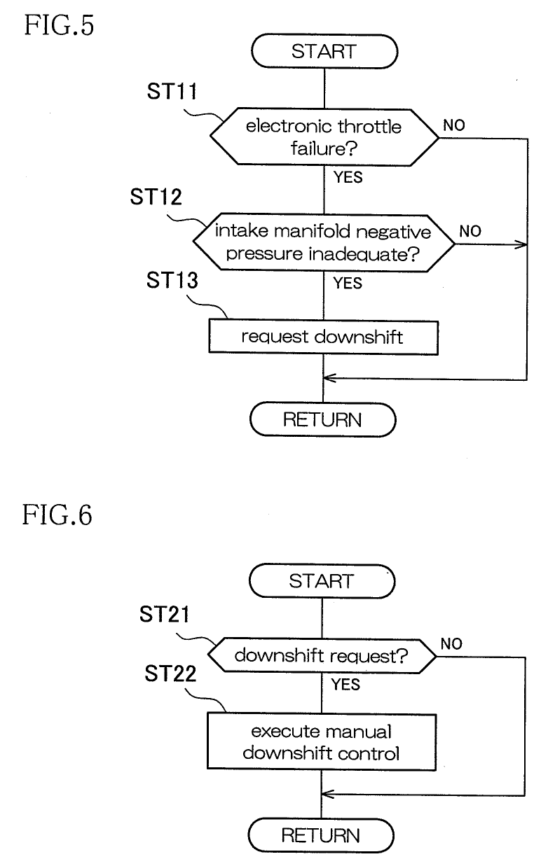

A specific example of that control (control during electronic throttle failure) will be described with reference to the flowchart shown in FIG. 5. The routine for control during electronic throttle failure in FIG. 5 is repeatedly executed in the engine ECU 101 at each of a predetermined time interval (for example, several ms).

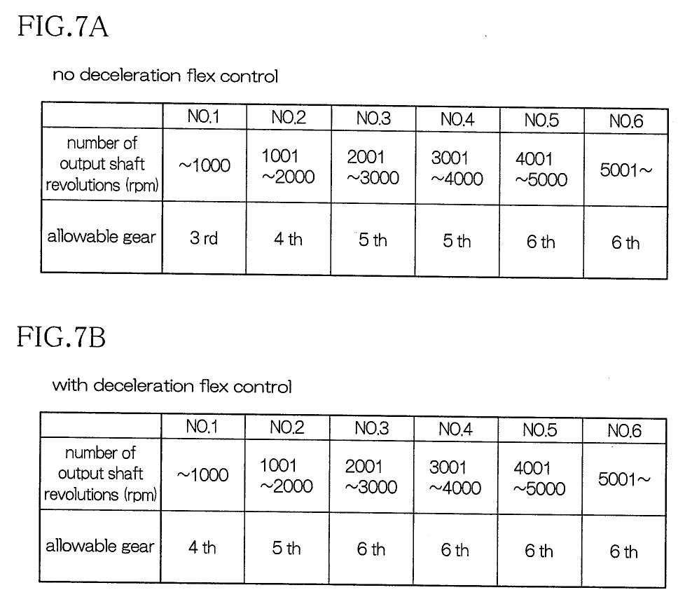

First, before describing the process in each step in FIG. 5, an allowable gear table used in the process of Step ST12 will be described with reference to FIGS. 7A and 7B.

The allowable gear table (no deceleration flex control) shown in FIG. 7A is a table used when determining whether or not a downshift of the automatic transmission 3 is necessary during an electronic throttle failure, and in this table, an allowable gear that makes it possible to insure intake manifold negative pressure is set for each of predetermined output shaft revolutions regions (each 1000 rpm) of the automatic transmission 3.

In the allowable gear table, for example, engine characteristic (number of output shaft revolutions, and intake manifold negative pressure for each gear) in a state in which the throttle valve 12 of the engine 1 is fixed at the throttle opening degree during electronic throttle failure (for example, 6°), is acquired by testing, calculation, and the like performed in advance, and based on that engine characteristic, a gear that makes it possible to insure intake manifold negative pressure is obtained through experience for each predetermined output shaft revolutions region (No. 1: 0 to 1000 rpm, No. 2: 1001 to 2000 rpm, . . . , No. 5: 4001 to 5000 rpm, No. 6: 5001 or more rpm), and converted to a table. This allowable gear table is stored in the ROM of the engine ECU 101.

Using this sort of allowable gear table (no deceleration flex control), it is possible to determine whether or not the intake manifold negative pressure is inadequate.

Specifically, when an allowable gear that is set in the allowable gear table shown in FIG. 7A is compared to the present gear of the automatic transmission 3, and the result of that comparison is [allowable gear<present gear], it is not possible to insure intake manifold negative pressure with the present gear, so a determination that “intake manifold negative pressure is inadequate” is made.

For example, in a case in which electronic throttle failure occurs when the vehicle is running in 6th gear, and at that time the number of output shaft revolutions of the automatic transmission 3 is 3500 rpm, the allowable gear obtained from the allowable gear table in FIG. 7A is 5th gear (region No. 4). However, because the present gear that is actually set in the automatic transmission 3 is 6th gear (allowable gear<present gear), a determination is made that “intake manifold negative pressure is inadequate”, and a downshift request described below is executed.

Also, in this present example, there may also be instances when deceleration flex control is executed, and it is necessary to change the allowable gear settings according to whether or not that deceleration flex control is executed. That is, when the deceleration flex control (slip control of the lockup clutch 25) is being executed, there is a tendency for the driven torque of the engine 1 to shift to the high side, so that the intake manifold negative pressure increases. In consideration of this point, for example, as shown in the allowable gear table (with deceleration flex control) in FIG. 7B, among the output shaft revolutions regions No. 1 to No. 6, in regions No. 1 to No. 4 the allowable gear is set one gear higher than in the allowable gear table (no deceleration flex control) in FIG. 7A.

Following is a specific description of the control when electronic throttle failure occurs with reference to FIG. 5.

First, in Step ST11, a determination is made of whether or not the electronic throttle has failed. When the result of that determination is affirmative (when the electronic throttle is normal), this routine is temporarily not performed. When the result of the determination in Step ST11 is negative, i.e. when the electronic throttle has failed, the process proceeds to Step ST 12. Note that when the electronic throttle has failed, control of the throttle opening degree is limited (prohibited), and the opening degree of the throttle valve 12 is fixed.

In Step ST12, a determination is made of whether or not intake manifold negative pressure is inadequate.

Specifically, first, by obtaining a ratio of revolutions (number of output revolutions/number of input revolutions) obtained from the output signals of the input shaft revolutions sensor 203 and the output shaft revolutions sensor 204, and determining the present gear, the number of output shaft revolutions is calculated from the output signal of the output shaft revolutions sensor 204. Next, based on the number of output shaft revolutions, the allowable gear (gear that can insure intake manifold negative pressure) is obtained by referring to the allowable gear table (no deceleration flex control) shown in FIG. 7A, and this allowable gear is compared to the present gear. When the result of that comparison is [allowable gear<present gear], a determination that “intake manifold negative pressure is inadequate” is made (result of the determination in Step ST12 is affirmative), and a downshift request is sent to the ECT_ECU 102 (Step ST13).

When performing the process of Step ST12, if deceleration flex control is being executed, the determination of whether or not intake manifold negative pressure is inadequate is made by referring to the allowable gear table (with deceleration flex control) shown in FIG. 7B.

In the ECT_ECU 102, as shown in FIG. 6, when a downshift request is received from the engine ECU 101 (when the result of the determination in Step ST21 is affirmative), regardless of the shift lines of the gearshift map shown in FIG. 4, a manual downshift control of the automatic transmission 3 is executed (Step ST22), and driven torque of the engine 1 is increased, thus insuring intake manifold negative pressure.

Next is a description of the manual downshift control executed in above Step ST22.

First, when a downshift request has been sent from the engine ECU 101 to the ECT_ECU 102, if the state of the engine torque is a driven state, the number of engine revolutions (number of input shaft revolutions of the automatic transmission 3) becomes a gear-synchronized number of revolutions after the downshift. On the contrary, if the engine 1 is in a driving state, there is no guarantee that the number of engine revolutions will rise to the gear-synchronized number of revolutions after the downshift by the engine 1's own power by the engine torque with the throttle opening degree (fixed) during electronic throttle failure.

On the other hand, when electronic throttle failure has occurred, as described above, the throttle opening degree of the throttle valve 12 is set regardless of operation of the accelerator pedal, so the relationship between the accelerator opening degree (non-linear throttle opening degree) and the actual throttle opening degree becomes offset, and thus it is not possible to determine whether the engine 1 is in a driven state/driving state. That is, during electronic throttle failure, it is not possible to determine whether the number of input shaft revolutions of the automatic transmission 3 reaches the gear-synchronized number of revolutions.

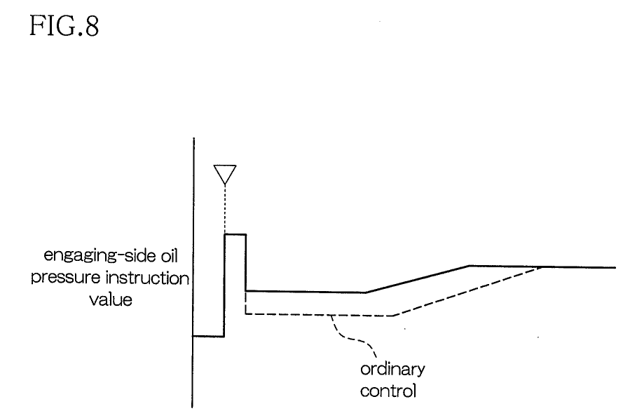

In consideration of such a point, in this example, when there was a downshift request during electronic throttle failure, regardless of the driving/driven state of the engine 1, as shown in FIG. 8, a manual downshift control is performed in which engaging oil pressure (oil pressure instruction value) of engaging-side engaging elements increases to more than during ordinary control, and thus the revolutions of the input shaft 33 of the automatic transmission 3 are elevated.

Specifically, for example, when downshifting from the fifth gear (5th) to the fourth gear (4th), clutch-to-clutch gearshift control (see FIG. 2) is performed that engages the first clutch C1 at the same time as releasing the third brake B3, so a downshift is performed by increasing engaging oil pressure (oil pressure instruction value) of the engaging-side first clutch C1 to more than during ordinary control, thus elevating the revolutions of the input shaft 33 of the automatic transmission 3.

As described above, according to this example, when control of the throttle opening degree is limited due to the occurrence of an electronic throttle failure, a determination is made of whether or not intake manifold negative pressure of the engine 1 is inadequate, and if the intake manifold negative pressure is inadequate, a downshift of the automatic transmission 3 is executed, thus increasing the intake manifold negative pressure (absolute value) by increasing the driven torque of the engine 1. Therefore, for example, when running at a high speed in a high gear, even if electronic throttle failure occurs, it is possible to insure intake manifold negative pressure, i.e. brake booster negative pressure, thus avoiding increased depressing force of the brake pedal 5 during electronic throttle failure. Accordingly, it is possible to lighten the burden of the depressing operation of the brake pedal 5 when the driver attempts to reduce speed after an electronic throttle failure.

Moreover, in this example, it is possible to insure intake manifold negative pressure during an electronic throttle failure without controlling the throttle opening degree in a failed state, and without adding a hardware structure.

-Other Embodiments-

In the above example, the present invention was applied to a vehicle equipped with an automatic transmission having six forward gears, but the present invention is not limited thereto, and is also applicable to driving force control of a vehicle equipped with a planetary gear-type automatic transmission having other gears as desired.

In the above example, gearshift control was executed by obtaining an appropriate gear based on the vehicle speed and the accelerator opening degree, but the present invention is not limited thereto; a configuration may also be adopted in which gearshift control is executed by obtaining an appropriate gear based on the vehicle speed and the throttle opening degree. Further, the present invention is also applicable to driving force control of a vehicle equipped with an automatic transmission that controls shifting of gears based on other parameters related to the running state of the vehicle.

In the above example, driving force control of a vehicle equipped with an automatic transmission having a planetary gear-type gearshift mechanism was described, but the present invention is not limited thereto, and is also applicable to, for example, driving force control of a vehicle equipped with a belt-type gearless transmission (CVT).

In the above example, the present invention was applied to driving force control of a vehicle equipped with a four-cylinder gasoline engine, but the present invention is not limited thereto, and is also applicable to driving force control of a vehicle equipped with a multi-cylinder gasoline engine having another number of cylinders as desired, such as, for example, a six-cylinder gasoline engine. Further, the present invention is not limited to gasoline engines, and is also applicable to driving force control of a vehicle equipped with another type of engine, such as a diesel engine. Also, the engine may be a port injection-type engine or may be a direct injection-type engine.

The present invention may be embodied in various other forms without departing from the gist or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

What is claimed is:

1. A driving force control apparatus for a vehicle equipped with an internal combustion engine and an automatic transmission connected to the internal combustion engine, the vehicle using intake pipe negative pressure of the internal combustion engine as brake booster negative pressure, the vehicle driving force control apparatus comprising:
a throttle control means for controlling a throttle opening degree of the internal combustion engine;
a malfunction detecting means for detecting a malfunctioning state of the throttle control means;
a throttle control limiting means for limiting control of the throttle opening degree when a malfunction has been detected by the malfunction detecting means;
a gearshift control means for controlling a gear ratio of the automatic transmission; and
a negative pressure determining means for determining whether or not the intake pipe negative pressure of the internal combustion engine is inadequate when control of the throttle opening degree is being limited;
wherein when the negative pressure determining means has determined that the intake pipe negative pressure is inadequate, the gearshift control means controls the gear ratio of the automatic transmission so as to shift to a gear ratio that increases the intake pipe negative pressure of the internal combustion engine.

2. The vehicle driving force control apparatus according to claim 1, wherein
the automatic transmission equipped in the vehicle is a planetary gear-type automatic transmission of a geared type that has a planetary gear-type gearshift mechanism, in which a plurality of gears are set by engaging or releasing one or more engaging elements in predetermined states; and
when the negative pressure determining means has determined that the intake pipe negative pressure is inadequate, the gearshift control means downshifts the gear of the planetary gear-type automatic transmission.

3. The vehicle driving force control apparatus according to claim 2, further comprising:
an output shaft revolutions detecting means for detecting the number of revolutions of an output shaft of the planetary gear-type automatic transmission; and
a gear determining means for determining the present gear of the planetary gear-type automatic transmission,
wherein the negative pressure determining means comprises a table in which an allowable gear that can insure intake pipe negative pressure is set for each of predetermined output shaft revolutions regions, the negative pressure determining means obtains an allowable gear based on the number of output shaft revolutions by referring to the table, compares the allowable gear to the present gear, and when the result of that comparison is that the allowable gear is less than the present gear, determines that intake pipe negative pressure is inadequate.

4. The vehicle driving force control apparatus according to claim 2, wherein
when the negative pressure determining means has determined that the intake pipe negative pressure is inadequate, when a downshift of the planetary gear-type automatic transmission is executed, an engaging oil pressure of one or more engaging-side engaging elements of the planetary gear-type automatic transmission is set higher than during ordinary control.

5. The vehicle driving force control apparatus according to claim 3, wherein
when the negative pressure determining means has determined that the intake pipe negative pressure is inadequate, when a downshift of the planetary gear-type automatic transmission is executed, an engaging oil pressure of one or more engaging-side engaging elements of the planetary gear-type automatic transmission is set higher than during ordinary control.

6. A driving force control apparatus for a vehicle equipped with an internal combustion engine and an automatic transmission connected to the internal combustion engine, the vehicle using intake pipe negative pressure of the internal combustion engine as brake booster negative pressure, the vehicle driving force control apparatus comprising:
a throttle controller for controlling a throttle opening degree of the internal combustion engine;
a malfunction detector for detecting a malfunctioning state of the throttle controller;
a throttle control limiter for limiting control of the throttle opening degree when a malfunction has been detected by the malfunction detector;
a gearshift controller for controlling a gear ratio of the automatic transmission; and
a negative pressure determiner for determining whether or not the intake pipe negative pressure of the internal combustion engine is inadequate when control of the throttle opening degree is being limited;
wherein when the negative pressure determiner has determined that the intake pipe negative pressure is inadequate, the gearshift controller controls the gear ratio of the automatic transmission so as to shift to a gear ratio that increases the intake pipe negative pressure of the internal combustion engine.

7. The vehicle driving force control apparatus according to claim 6, wherein
the automatic transmission equipped in the vehicle is a planetary gear-type automatic transmission of a geared type that has a planetary gear-type gearshift mechanism, in which a plurality of gears are set by engaging or releasing one or more engaging elements in predetermined states; and
when the negative pressure determiner has determined that the intake pipe negative pressure is inadequate, the gearshift controller downshifts the gear of the planetary gear-type automatic transmission.

8. The vehicle driving force control apparatus according to claim 7, further comprising:
an output shaft revolutions detector for detecting the number of revolutions of an output shaft of the planetary gear-type automatic transmission; and
a gear determiner for determining the present gear of the planetary gear-type automatic transmission,
wherein the negative pressure determiner comprises a table in which an allowable gear that can insure intake pipe negative pressure is set for each of predetermined output shaft revolutions regions, the negative pressure determiner obtains an allowable gear based on the number of output shaft revolutions by referring to the table, compares the allowable gear to the present gear, and when the result of that comparison is that the allowable gear is less than the present gear, determines that intake pipe negative pressure is inadequate.

9. The vehicle driving force control apparatus according to claim 7, wherein
when the negative pressure determiner has determined that the intake pipe negative pressure is inadequate, when a downshift of the planetary gear-type automatic transmission is executed, an engaging oil pressure of one or more engaging-side engaging elements of the planetary gear-type automatic transmission is set higher than during ordinary control.

10. The vehicle driving force control apparatus according to claim 8, wherein
when the negative pressure determiner has determined that the intake pipe negative pressure is inadequate, when a downshift of the planetary gear-type automatic transmission is executed, an engaging oil pressure of one or more engaging-side engaging elements of the planetary gear-type automatic transmission is set higher than during ordinary control.
